(19) United States
(12) Patent Application Publication
(10) Pub. No.: US 2012/0158595 A1
(43) Pub. Date: Jun. 21, 2012

(54) OPERATOR EXTERNAL SERVICE PROVISIONING AND CHARGING

(75) Inventor: Joel CASSEL, Rodeby (SE)

(73) Assignee: TELEFONAKTIEBOLAGET LM ERICSSON (PUBL), Stockholm (SE)

(21) Appl. No.: 12/968,474

(22) Filed: Dec. 15, 2010

(51) Int. Cl. G06Q 30/00; G06Q 20/00; H04L 9/32; H04L 9/28

(52) U.S. Cl. 705/75

(57) ABSTRACT

Presented is a system and methods for allowing a user, through their end user device, to online purchase a service from a service provider and provide online payment for the service from the operator network associated with the end user device. The service provider and the operator network can authenticate each other through encrypted data appended to HTTP communications associated with interacting on the internet.

### TECHNICAL FIELD

The present invention relates generally to online service provisioning and charging systems and more specifically to authentication, authorization and accounting between an end user and a service provider.

### BACKGROUND

The availability of online services for sale on the internet has grown exponentially over the past few years. Examples of online services include game sites such as role playing and poker, consumer goods sites of all imaginable categories, music and video sites and news and sports outlet sites. Historically, purchasing online services involved the end user creating an account with each service provider and providing financial information, such as a bank account or credit card, to each service provider for allowing the service provider to charge the end user for the service. An immediate problem for this method of service payment is the fact that not all users have access to a credit card or bank account information, especially in the developing countries. Providing a mechanism for this client base to purchase online services will solve a long standing problem for society and allow for the development of a significant revenue source.

As the number of available services grew, the number of online accounts managed by the end user became unwieldy for reasons such as remembering login and password information or updating accounts whenever a credit card expired or a bank account changed. In another undesirable aspect, the end user must login each time he/she wishes to use the service. A solution to this problem should include the ability to validate that the user has permission to access an online service without requiring a login for each instance of use or service timeout and disconnect from inactivity.

Further, end users also became uncomfortable with the number of online locations holding sensitive financial information. A solution is desired where the end user can purchase online services without disclosing financial information to every service provider. In another circumstance, certain services, such as the one-time purchase of a daily newspaper while traveling proved too insignificant to justify the requirement of creating an account and providing the required financial information, therefore frustrating the end user. As described above for other service providers, the ability to make micro-payments for one-time purchase without creating an account and entering financial information is a desirable attribute of a solution.

Another complicating factor for end users involved the number of devices owned by a given end user. Each end user device such as a mobile phone, personal computer, television or music player required identification and authentication to the service provider before service access was allowed, even though the end user was already validated on other devices he/she owned. This, once again, resulted in login requirements from each device and in some cases a login in from certain devices, such as a television, was at least impractical if not impossible. Accordingly, another aspect of a solution is the desirability of allowing authentication of all devices associated with an end user's account without requiring the end user to login from each device.

In one attempt to remedy these concerns, network operators provided a mechanism for service providers to add their charges to an end user's monthly bill. The implementation involved the time consuming steps of executing a contract between a network operator and a service provider, defining payment amounts, terms and other rights and responsibilities. Next, the service provider had to implement system level support for contacting the network operator account system directly for service provisioning and enquiry. This burden was multiplied for both the network operator and the service provider because of the multitude of service providers and network operators in the market. The high level of effort on both the network operator and the service provider resulted in differing and sometimes irreconcilable views on revenue sharing regarding the cost of integrating and maintaining the infrastructure.

In another attempt, some network operators and service providers implemented a Short Message Service (SMS) system, basically text messaging, for presenting terms of usage and delivering a pass-code. Problems related to this implementation surfaced quickly. In one instance, the maximum message length proved too short for delivering terms of service agreements and the results of using multiple messages varied from too complex to completely unworkable based on the length of the agreement. In another instance, the SMS network was too slow or, in the case of some end user devices, not implemented, therefore acting as a total ban to service purchase.

Consequently, market pressure is building for a solution which would allow a service provider to authenticate that a service has been paid for by the operator network responsible for the account of the end user device requesting the service without requiring the service provider to contact the operator network directly for service enquiry. Accordingly, it would be desirable to allow an operator network to transparently determine that an end user device, associated with an account on the operator network, is attempting to access an online service and based on this access, interact with the service provider to credit the service provider and debit the end user device account for the cost of the online service. Further, the service provider should not be required to make system changes specific to a particular network operator's online charging system.

### SUMMARY

Systems and methods according to the present invention address the market needs described above by providing an external service provisioning and charging system. Exemplary embodiments allow an internet based service provider to authenticate that a service has been paid for by an end user device owning network operator without having to contact the network operator directly for service enquiry.

In one exemplary embodiment, a network operator external service provisioning is achieved using smart hypertext transfer protocol (HTTP) redirect uniform resource locators (URLs) when using an internet browser based communication between an end user device, a network operator and a service provider. The network operator implementation divides the processing between a Gateway General Packet Radio Service (GPRS) Support Node (GGSN) and the Online Charging System (OCS). The addition of an encryption scheme using the public/private key pair owned by the network provider allows for the authentication of the transactions between the operator network and the service provider. The service provider implementation provides for recognizing known attributes and destinations shared between the service provider and the network operator and using a public key provided by the network operator to decrypt authentication data sets for end user device validation before providing the requested service to the end user device.

In another exemplary embodiment, the network operator external service provisioning provides the capability for internet based external service providers to enable an online service and charge the cost of providing the service through the network operator on the network operator owned account of the end user device. The service provisioning is triggered by external service enablers outside the network operator main infrastructure. In a further aspect, the service provider and the network operator can share the charge for the service without the need for complicated negotiations based on distributing the cost of infrastructure development and maintenance. Exemplary embodiments provide a mechanism for network operators and service providers to enable services, setup sessions and charge end user device accounts over the internet for other devices owned by the end user but not initially used to provision the service.

In a further aspect of an exemplary embodiment, the end user's financial information is protected because it is known by only the network operator, any service provider requesting validation does not access any account information associated with the end user device account. Under these circumstances, the end user is not required to have a credit card or even access to bank account information for purchasing a service from a service provider. Further, the service provider can validate that other devices owned by the user and associated with the end user device account can access the service without creating additional accounts with the service provider or logging in to prove the additional devices are allowed to use the service.

In yet another aspect of an exemplary embodiment, the service provider can authenticate the end user device request for service access based on the identity of the end user device on the operator network without requiring the end user to enter login information at the end user device. A system implemented as described in exemplary embodiments therefore eliminates the barriers to micro-payment purchases of one-time services and to the end user frustration of entering login information each time a service is accessed or times out.

In another aspect of an exemplary embodiment, the network operator and the service provider can share the charge for the online service by a simple percentage split. Since exemplary embodiments do not require system changes to the service provider infrastructure or system maintenance by the network operator, there is no need for complicated formulas regarding how to divide the revenue from the charges associated with service purchase. Further, in another aspect of an exemplary embodiment, because the network operator provides the decryption key to the service provider in the form of the public half of a public/private key pair, the service provider is assured that once the encrypted authentication data set is decrypted and validated, the service provider will receive payment for the service. Exemplary embodiments also effectively eliminate the possibility of fraud in service acquisition by either an end user or a service provider.

In another exemplary embodiment, a method for provisioning and charging on an operator network, an external service selected by an end user device associated with the operator network is presented. The method includes the following steps. First, the operator network receives a first communication from an end user device. Next, the operator network appends a parameter identifying the operator network to the first communication. Continuing, the operator network forwards the first communication toward a first destination associated with the external service and specified in the first communication. Next, the operator network receives a second communication, replying to the first communication, and parses the second communication for an identifier specified in the second communication and identifying the operator network. Continuing, the operator network processes the identified second communication to charge an account, associated with the end user device, for the cost of the external service. Next, the operator network encrypts an authentication data set, using a key associated with the operator network, and transmits a third communication, including the encrypted authentication data set, toward the end user.

In another exemplary embodiment, a method for delivering an external service from a service provider to an end user device, associated with an operator network, and charging the operator network for the external service without the service provider accessing the account, associated with the end user device and located on the operator network, is presented. The method includes the following steps. First, the service provider receives a first communication from an end user device requesting access to an external service. Next, the service provider parses the first communication and based on recognizing an identifier in the first communication identifying an operator network, processing the first communication to request authorization from the operator network to charge the account for the external service. Continuing, the service provider forwards the first communication toward a first destination. Next, the service provider receives a second communication from the operator network requesting the external service and including an authentication data set encrypted by the operator network. Next, the service provider extracts the encrypted authentication data set from the second communication, decrypts the authentication data set with a key associated with the operator network and validates that the end user device is authorized to receive the external service and the end user device account has been charged. Then, the service provider transmits the external service toward the authorized end user device.

### BRIEF DESCRIPTION OF THE DRAWINGS

The accompanying drawings illustrate exemplary embodiments, wherein:

FIG. 1 depicts a system for a service provider to provision on and charge to a network operator owned user account, based on an end user device selecting an external service according to an exemplary embodiment;

FIG. 2 depicts a system, facilitated by a GGSN and an Online Charging System (OCS), for a service provider to provision on and charge to a network operator owned user account, based on an end user device selecting an external service according to an exemplary embodiment;

FIG. 3 depicts a system, facilitated by a GGSN, a Charging Control Node (CCN) and a Service Data Point (SDP), for a service provider to provision on and charge to a network operator owned user account, based on an end user device selecting an external service according to an exemplary embodiment;

FIG. 4 depicts a system, facilitated by a third-party payment provider, for a service provider to provision on and charge to a network operator owned user account, based on an end user device selecting an external service according to an exemplary embodiment;

FIG. 5 is a flowchart depicting differences, based on prior art, in input required to purchase an external service, according to an exemplary embodiment;

FIG. 6 is a flowchart depicting a network operator method for a service provider to provision on and charge to a network operator owned user account according to an exemplary embodiment;

FIG. 7 is a flowchart depicting a method for a service provider to provision on and charge to a network operator owned user account according to an exemplary embodiment; and

FIG. 8 depicts an exemplary computing device for implementing a system for a service provider to provision on and charge to a network operator owned user account, based on an end user device selecting an external service according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

In general, exemplary embodiments provide authenticated, TCP based Internet Protocol (IP) service provisioning and charging between an end user device and a service provider without allowing the service provider access to operator owned end user device account information or consequently requiring the service provider to implement system level changes associated with accessing the end user device account information. A service provider can respond to an end user device request for access to an external service by authenticating the end user device with the operator network associated with the end user device through a series of TCP based exchanges. Part of the TCP based exchange includes provisioning the external service on the end user device account and charging the end user device account for the cost of the external service.

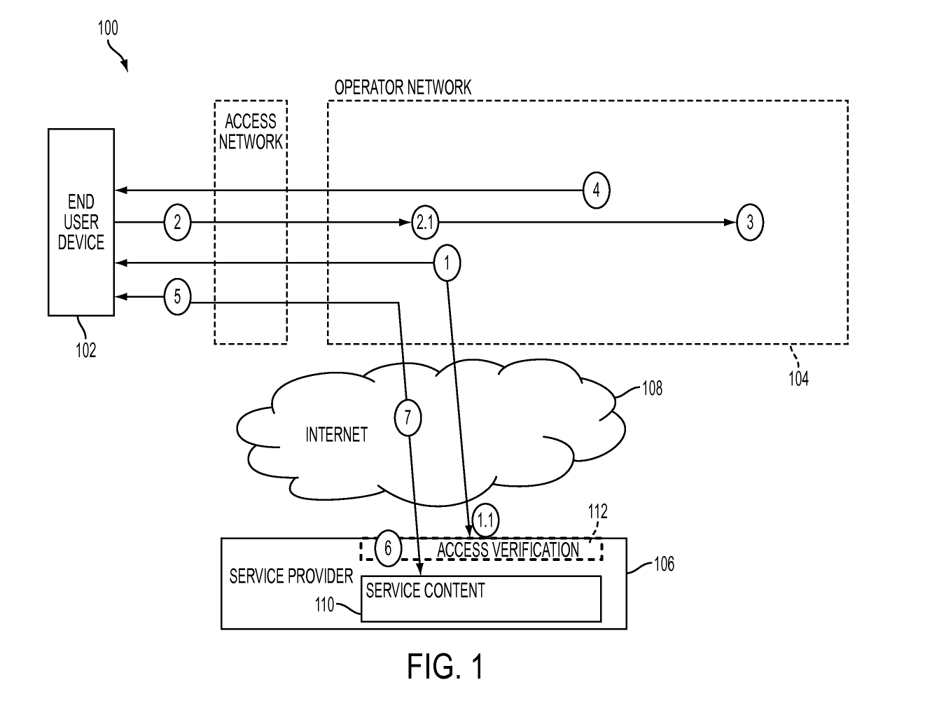

Looking first to FIG. 1, a diagram of an exemplary operator external service enabler provisioning and charging system 100 is illustrated. Beginning on path 1, the end user device 102 initiates the interaction by selecting an external service 110 from a service provider 106 via the internet 108. The end user device 102 can, for example, be a cellular telephone but can also be a television, a video game system, a personal computer, a music player or any such device capable of communicating over the internet 108 and requesting access to an external service 110. In another aspect of an exemplary embodiment, the end user device 102 is associated with the operator network 104 with respect to an account owned by the operator network 104 and billable to the end user based on accumulated charges incurred by the end user device 102. An exemplary operator network 104 is a telecommunications company network providing cellular and wire-based communications.

Continuing on path 1, when the end user device 102 request passes through the operator network 104, the operator network 104 appends an identifying attribute to the end user device 102 request and forwards the end user device 102 request along path 1.1 to the service provider 106. The service provider 106 is a third-party with respect to the operator network 104 and provides an external service 110 to any internet 108 user requesting use of the external service 110. When the end user device 102 request arrives at the service provider 106, an access verification component 112 analyzes the request. The access verification component 112 determines if the end user device request represents a valid request to use a particular external service 110, including accessing online content.

In another aspect, the access verification component 112 recognizes the operator network 104 identifying attribute, appended to the end user device 102 request by the operator network 104, and generates a response to the end user device 102 request. The response, according to this exemplary embodiment, includes a destination address known to the operator network 104 as a request for provisioning and/or charging or validation of the associated end user device 102, a service identity and a final destination address to send an authenticated request for the external service 110. The service provider 106 returns this response as an automatic redirection request, on path 1, to the end user device 102 who then redirects the response, on path 2, to the operator network 104. Redirection by the end user device 102 can be automatic or can include interaction by the end user.

Next, the operator network 104, at 2.1, recognizes the known destination address as a request to provision and/or charge or validate the end user device 102 for accessing the external service 110 and, at 3, processes the request against the end user device 102 account. Continuing at 3, the operator network 104 parses the service identifier from the request and determines if the desired external service is already provisioned on the end user device 102 account. If the external service 110 is not provisioned on the end user device 102 account, then the operator network 104 provisions the external service on the end user device 102 account and charges the end user device 102 account for the external service 110. Next, at 3, the operator network 104 encrypts authentication data with an operator network 104 owned private key.

Continuing at 4, the encrypted authentication data is combined with an address of the desired external service 110 and sent to the end user device 102. The end user device 102, at 5, then sends the encrypted authentication data to the address of the external service 110, requesting access. The access verification component 112, at 6, decrypts the authentication data with the public key provided by the operator network 104 to validate the requested access. Next, at 7, the service provider 106 allows access to the external service 110 by the authenticated end user device 102.

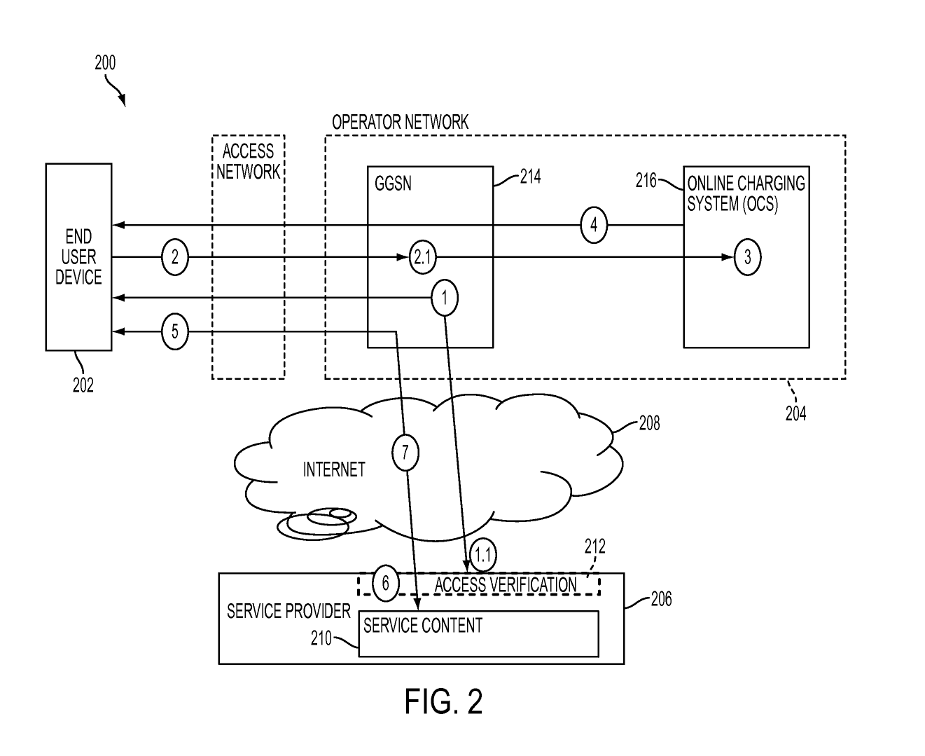

For a more detailed example, looking now to FIG. 2, another exemplary embodiment 200 is depicted. The exemplary embodiment 200 depicts a portion of an operator network 204 comprising a GGSN 214 and an Online Charging System (OCS) 216. Further, the transmission control protocol (TCP) in this embodiment is the Hypertext Transfer Protocol (HTTP).

The end user device 202 requests access to a desired external service 210 using an URL (web link) to a service provider 206 (e.g. http://serviceprovider.com/externalservice) e.g., by clicking on a link on the service provider's web page that is intended to initiate service delivery. A parameter is appended to the request by the GGSN 214 to identify the request as coming from the GGSN 214. The parameter identifies the operator network 204 and notifies the service provider 206 to allow operator network 204 charging for the external service 210. However, access to the external service is not immediately allowed by the access verification component 212 of the service provider 206. Instead a specific HTTP-redirect URL (or user clickable link) is sent back to the end user device 202. The redirect URL indicates a special handling based on a charging server name (e.g. http://<ChargingServerName>?SID=<ServiceEnabler>&ServiceURL=<ServiceContentFinalURL>) and the end user device 202 requests access to the responded URL (automatic if redirected, manually if clicked).

Next, the GGSN 214 recognizes the known charging server name and generates an Authentication, Authorization and Accounting (AAA) protocol message. In this exemplary embodiment, the Diameter protocol is selected. The GGSN 214 sets a unique Diameter service identifier, appends the full redirect URL and sends the Diameter message towards the OCS 216.

Next, the OCS 216 processes the message and interprets the received service identifier as a request for service enabler processing for the end user device 202 account. If the service enabler is not provisioned on the end user device 202 account, then the OCS 216 provisions the service enabler on the end user device 202 account and charges the end user device 202 account for the cost of the external service 210. If the service enabler is provisioned, either already active on the end user device 202 account or as just provisioned and charged above, the OCS 216 generates a response to the Diameter message request.

The Diameter response prepared by the OCS 216 according to this exemplary embodiment comprises an encrypted authentication data set and the service content final URL specified in the Diameter request. The OCS 216 sends the prepared redirect URL response (e.g. http://<ServiceContentFinalURL>&authenticated=<EncryptedData>) toward the GGSN 214. It should be noted that the response can, for example, be a Diameter “Redirect-Server-Address” (RSA) in conjunction with a “FinalUnitIndication” (FUI) but in another exemplary embodiment, the Diameter based protocol can be modified to allow a RSA without requiring a FUI.

Next, the GGSN 214 generates an HTTP redirect URL based on the Diameter protocol response received from the OCS 216 and sends the HTTP redirect URL toward the end user device 202. The end user device 202 automatically requests the received HTTP redirect URL. Next, the service provider 206 access verification component 212 decrypts the encrypted authentication data set with the operator network 204 public key. The access verification component 212 validates the authentication data set and, if valid, grants access to the external service 210. The service provider 206 then allows the start of a normal HTTP session between the end user device 202 and the external service 210.

It should be noted that the “ChargingServerName” (e.g. charging.telco.com) is, for example, a server name used by the GGSN 214 to distinguish communications associated with operator network 204 billing. The name requires configuration in the GGSN 214 redirect rules but does not require an actual server connection.

Similarly, “ServiceEnabler,” alternatively known as a “ServiceID” (SID), is a unique service identifier for the requested external service 210. Non-limiting examples include text or numeric identifiers and, if the identifier is set on the end user device 202 account, then the user has access to the external service 210, regardless of which network operator 204 associated end user device 202 the user is using. Non-limiting examples of a “ServiceEnabler” include “StreamingVideoAtServiceProviderYY_CategoryAA_ID12,” “ServiceProviderCampaign15,” “NewspaperYYSubscriptionMyCompanyXX_OK” and “523452345.”

Further, “ServiceContentFinalURL” is a link to the external service 210 requested from the service provider 206 and contains a full URL-encoded link to the requested external service 210. A Non-limiting example includes “http://serviceprovider.com/servicecontent?ID=AAA.” The service provider 206 is responsible for providing the parameters appropriate for the external service 210. For a non-limiting example, parameters can include service, category, price, time, etc.

Noting further, “EncryptedData” is an encrypted sequence of characters. The encryption is accomplished using the operator network owned private key of a public/private key pair. This scheme allows the receiving part (service provider 206) to authenticate the URL message as an operator network 204 approved service by decrypting using the operator network 204 provided public key. For a non-limiting example, the decrypted data can be the full URL of the external service 210 in clear text. It should be noted that a timestamp and/or transaction identity can be included in the encrypted data for increased security. A non-limiting example of encrypted data is http://<ChargingServerName>?SID=<ServiceEnabler>&ServiceURL=<ServiceContentFinalURL>&TimeStamp=12:34:43. Accordingly, it should be noted that the operator network 204 public key is made available to the service provider 206.

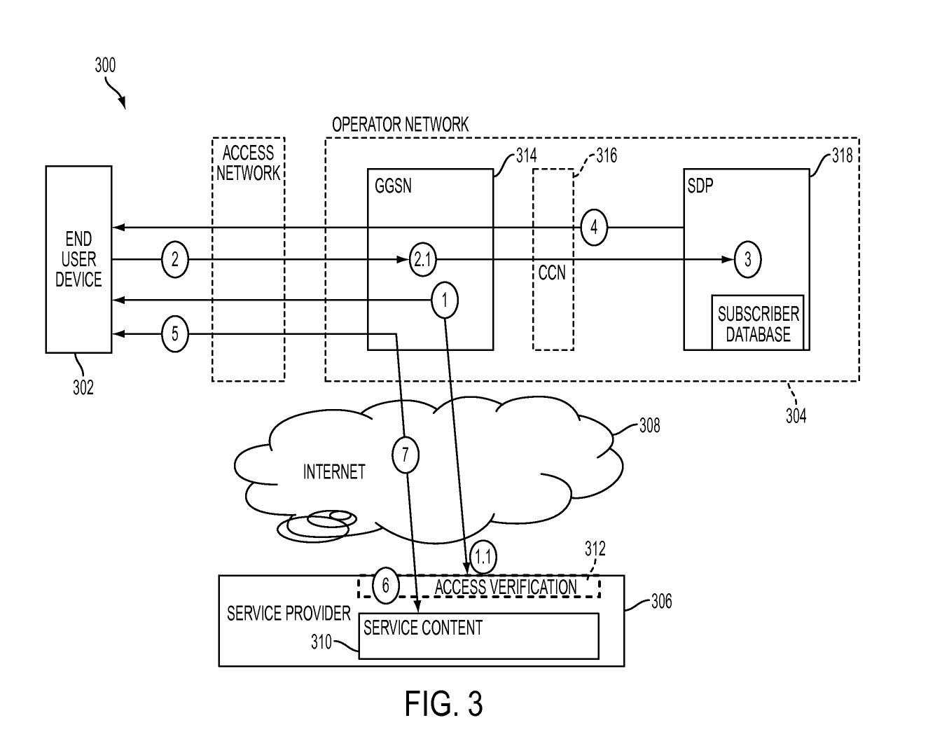

Turning now to FIG. 3, another exemplary embodiment is depicted. The exemplary embodiment depicts a portion of an operator network 304 comprising a GGSN 314, a Charging Control Node (CCN) and a Service Data Point (SDP). Further, the transmission control protocol (TCP) is the Hypertext Transfer Protocol (HTTP/1.1).

The end user device 302 requests access to a desired external service 310 using an URL (web link) to a service provider 306 (e.g. http://serviceprovider.com/externalservice) e.g., by clicking on a link on the service provider's web page that is intended to initiate service delivery. A parameter is appended to the request by the GGSN 314 to identify the request as coming from the GGSN 314. The parameter identifies the operator network 304 and notifies the service provider 306 to allow operator network 304 charging for the external service 310. However, access to the external service is not immediately allowed by the access verification component 312 of the service provider 306. Instead a specific HTTP/1.1-redirect URL (or user clickable link) is sent back to the end user device 302. The redirect URL indicates a special handling based on a charging server name (e.g. http://onlinecharge.operator.com?SID=13423&category=4&price=20 &serviceURL=www.serviceprovider.com/content?service=13423) and the end user device 302 requests access to the responded URL (automatic if redirected, manually if clicked).

Next, the GGSN 314 recognizes the known charging server name and generates an AAA protocol message. In this exemplary embodiment, the Diameter protocol is selected. The GGSN 314 sets a unique Diameter service identifier, appends the full redirect URL and sends the Diameter message towards the CCN 316. The CCN 316 then forwards the request to the SDP 318.

Next, the SDP 318 processes the message and interprets the service identifier as a request for service enabler processing for the end user device 302 account. The SDP 318 determines if the service enabler is provisioned on the end user device 302 account or any shared account associated with the end user device 302 account. If the service identifier does not exist, based on the “category” and “price” attributes, then a cost is deducted from the end user device 302 account, assuming sufficient funds exist, and the SDP 318 provisions the service enabler on the end user device 302 account by adding the SID (13423) to the persistent end user device 302 account information. If the service enabler is provisioned, either already active on the end user device 302 account or as just provisioned and charged above, the SDP 318 generates a response to the Diameter message request.

The Diameter response prepared by the SDP 318 comprises an encrypted authentication data set and the service content final URL specified in the Diameter request. The SDP 318 sends the Diameter redirect URL response (e.g. http://www.serviceprovider.com/content?service=13423&authenticated=ASDFLDEKJFFSSWJWEIRSDADSFASD) toward the GGSN 314. It should be noted that in one exemplary embodiment, an in-session HTTP redirect is used.

Next, the GGSN 314 generates an HTTP redirect URL (according to HTTP/1.1) based on the Diameter protocol response received from the SDP 318 and sends the HTTP redirect URL toward the end user device 302. The end user device 302 automatically requests the received HTTP redirect URL. Next, the service provider 306 access verification component 312 decrypts the encrypted authentication data set with the operator network 304 public key. The access verification component 312 validates the authentication data set and, if valid, grants access to the external service 310. The exemplary decrypted authentication data set would read “http://onlinecharge.operator.com?SID=13423&category=4&price=20&ServiceURL=www.serviceprovider.com/content?service=13423&Timestamp=12:44:32.” The service provider 306 then allows the start of a normal HTTP session between the end user device 302 and the external service 310. It should be noted that the service content could also be of type peer-to-peer (P2P) between the end user device 302 and another network entity.

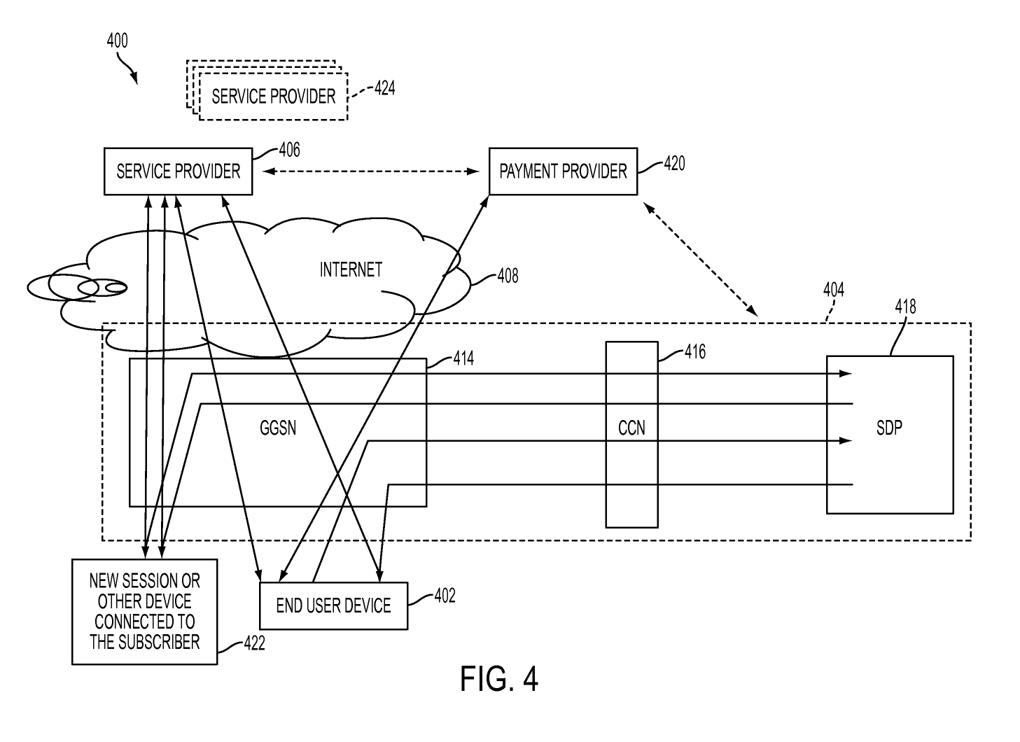

Turning now to FIG. 4, illustrated is yet another exemplary embodiment 400. The exemplary embodiment depicts a third-party payment provider 420 and a plurality of additional devices 422 associated with the end user device 402 account. It should be noted that a one-time exchange of public encryption keys and secure reimbursement contracts occurs between the payment provider 420 and operator network 404. It should be further noted that the payment provider 420 is the only entity in human contact with the service providers 406.

The end user device 402 requests access to a desired external service 410 using an URL (web link) to a service provider 406 (e.g. http://serviceprovider.com/externalservice). It should be noted that a parameter is appended to the request by the GGSN 414 to identify the request as coming from a GGSN 414. The parameter notifies the service provider 406 to allow operator network 404 charging for the external service 410. Next, the end user device 402 receives a web page comprising service purchase information and a link to the payment provider 420. An exemplary link to a payment provider is “http://paymentportal.com/companyYY/serviceXX?category=AA&price=BB&validDays=30&SID=12345.”

Next, the end user, at the end user device 402, selects the payment provider 420 purchase page and the payment provider 420 purchase page displays service information comprising terms of use, cost and a buy/purchase button associated with a purchase link. An exemplary purchase link is “http://charging.telecomcompany.com/companyYY/serviceXX?category=AA&price=BB&ValidTime=30&SID=12345&ServiceURL=<ServiceContentFinalURL>&authenticated=<EncryptedData>.”

Continuing, at the end user device 402, the end user selects to purchase the service and the GGSN 414 recognizes the known charging server name and generates an AAA protocol message. In this exemplary embodiment, the Diameter protocol is selected. The GGSN 414 sets a unique Diameter service identifier, appends the full redirect URL and sends the Diameter message towards the CCN 416. The CCN 416 then forwards the request to the SDP 418.

Next, the SDP 418 processes the message and interprets the service identifier as a request for service enabler processing for the end user device 402 account. Continuing, the SDP 418 decrypts the “EncryptedData” using the public key provided by the payment provider 420. If the decryption indicates an authentic request and therefore a trusted payment provider 420, then the SDP 418 determines if the service enabler is provisioned on the end user device 402 account or any shared account associated with the end user device 402 account. If the service identifier does not exist, based on the “category” and/or “price” attributes, then a cost is deducted from the end user device 402 account, assuming sufficient funds exist, and the SDP 418 provisions the service enabler on the end user device 402 account by adding the SID (12345) to the persistent end user device 402 account information. It should be noted that the operator network 404 can charge the end user device 402 account a pre-determined price or adjust a base price by a percentage amount based on the selected external service 410. If the service enabler is provisioned, either already active on the end user device 402 account or as just provisioned and charged above, the SDP 418 generates a response to the Diameter message request.

The Diameter response prepared by the SDP 418 comprises an encrypted authentication data set, the service identity and the service content final URL specified in the Diameter request. The SDP 418 sends the Diameter redirect URL response (e.g. http://<ServiceContentFinalURL>?SID=12345&authenticated=<EncryptedData>) toward the GGSN 414.

Next, the GGSN 414 generates an HTTP redirect URL (according to HTTP/1.1) based on the Diameter protocol response received from the SDP 418 and sends the HTTP redirect URL toward the end user device 402. The end user device 402 automatically requests the received HTTP redirect URL. Next, the service provider 406 decrypts the encrypted authentication data set with the operator network 404 public key. The service provider 406 validates the authentication data set and, if valid, grants access to the requested service. The service provider can save a copy (receipt) of the SID to its own subscriber account. In this context, the service ID can be an indicator of service access rights or money collectible from the payment provider 420. The service provider 406 then allows the start of a normal HTTP session between the end user device 402 and the service provider 406.

In another exemplary embodiment, another end user device 422 associated with the end user device 402 account, requests service from the service provider 406. Based on this request, the service provider 406 can send a verification request to the operator network 404. A non-limiting exemplary verification request is http://charging.telecomcompany.com/verify?SID=12345&Destination=<FinalDestinationURL>. It should be noted that for increased security, the verification request can contain an encrypted part using a private key associated with the service provider 406.

Next, the GGSN 414 recognizes the known charging server name and generates an AAA protocol message. In this exemplary embodiment, the Diameter protocol is selected. The GGSN 414 sets a unique Diameter service identifier (representing a verify request), appends the full redirect URL and sends the Diameter message towards the CCN 416. The CCN 416 then forwards the request to the SDP 418.

Next, the SDP 418 processes the message and determines if the end user device 422 account is already provisioned with the requested SID. If the service identifier does not exist, based on the SID attribute, then the SDP 418 sends generates a redirect URL towards the end user device 422 excluding the encrypted authentication data set. An exemplary non-limiting example of this validation request response is “http://<ServiceContentFinalURL>?SID=12345.” The end user device 422 then requests the service content and the service provider 406, recognizing a failed verification, can proceed with the charging scenario detailed above for exemplary embodiment 400. If the service enabler is provisioned, the SDP 418 generates a response to the Diameter message request.

The Diameter response prepared by the SDP 418 comprises an encrypted authentication data set, the service identity and the service content final URL specified in the Diameter request. The SDP 418 sends the redirect URL response (e.g. http://<ServiceContentFinalURL>?SID=12345&authenticated=<EncryptedData>) toward the GGSN 414.

Next, the GGSN 414 generates an HTTP redirect URL (according to HTTP/1.1) based on the Diameter protocol response received from the SDP 418 and sends the HTTP redirect URL toward the end user device 402. The end user device 402 automatically requests the received HTTP redirect URL. Next, the service provider 406 decrypts the encrypted authentication data set with the operator network 404 public key. The service provider 412 validates the authentication data set and, if valid, grants access to the requested service. The service provider can save a copy (receipt) of the SID to its own subscriber account. In this context, the service ID can be an indicator of service access rights or money collectible from the payment provider 420. The service provider 406 then allows the start of a normal HTTP session between the end user device 402 and the service provider 406.

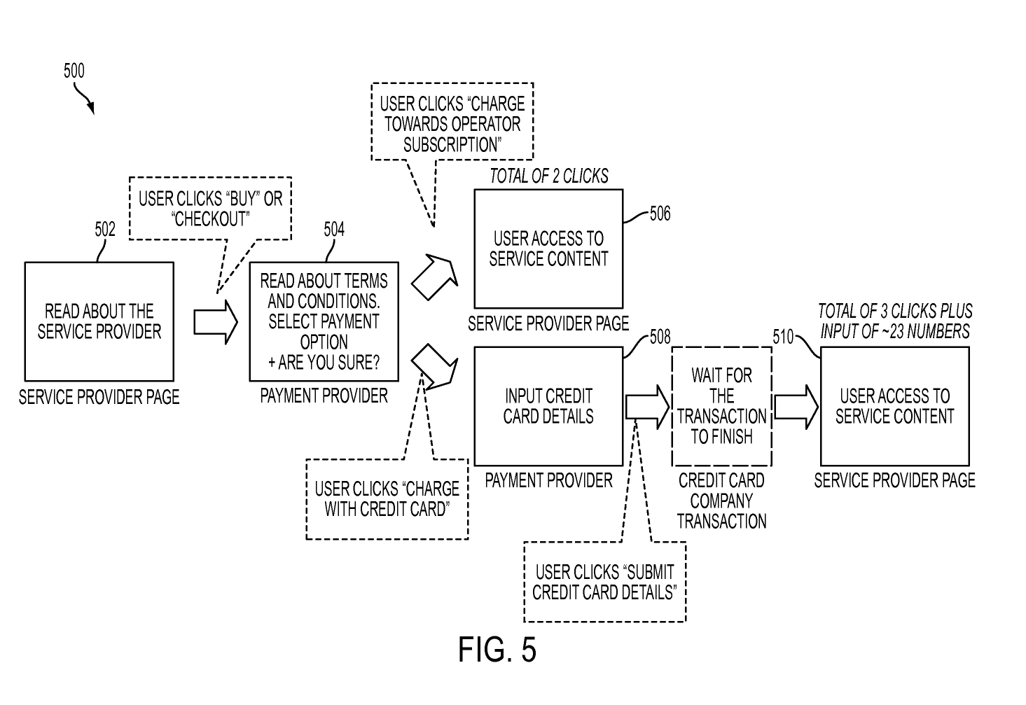

Looking now to FIG. 5, a flow chart comparing a user's experience according to exemplary embodiments versus a user's traditional experience with a credit card purchase is illustrated. Starting at 502, a user navigates to a web page on a service provider's web site. The web page offers a service for sale and the user decides to purchase the service online and clicks on a button to purchase the service. Continuing to 504, the user is presented another web page containing terms of use and costs associated with purchasing the service. The user clicks on another button to acknowledge his acceptance of the terms and cost and to deliver the service. Not shown in FIG. 5, the operator network and service provider interact with each other as described above to charge for the requested external service, potentially without any further interaction from the end user. At this point the user has made two mouse clicks and according to the subject invention the user, at 506, now has access to the purchased service.

By way of contrast, with the traditional credit card purchase at 508, the user is required to enter at least twenty and usually twenty-three numbers. The numbers include the sixteen digit credit card account number, the four digit expiration date and usually the three digit security code on the back of the credit card allegedly indicating physical possession of the credit card. After entering all these numbers, the user must click another button to submit the information to the service provider. Before responding, the service provider must process the submitted credit card information and forward a validation request toward the credit card company. The time required to receive a validation response is indeterminate and in some cases can take a frustratingly long period of time. Finally, the validation response is received from the credit card company and, at 510, the user has access to the purchased service.

In summary, using the service provisioning an charging according to exemplary embodiments, the user makes two mouse clicks to purchase an online service and using the traditional credit card purchasing arrangement, makes three mouse clicks and enters twenty-three numbers to purchase the same service. The traditional credit card purchasing arrangement also requires a waiting period while the service provider waits for a validation response from the credit card company.

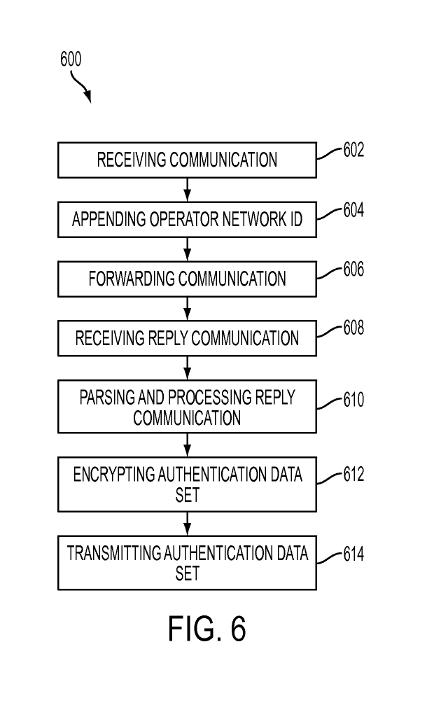

Looking now to FIG. 6, a method 600 based on provisioning and charging and end user device account on an operator network for an external service purchased from a service provider according to an exemplary embodiment is depicted. Starting at step 602, the operator network receives a first communication from an end user device for purchasing an external service, the first communication directed toward a service provider. The first communication can be an HTTP protocol based communication such as a website address for a service provider. Next at step 604, the operator network appends a parameter identifying the operator network to the first communication. A non-limiting example of a parameter identifying an operator network can be an URL such as “OnlineCharge.TelecomCompany.com.”

Continuing to step 606, the operator network forwards the first communication to the addressed service provider. Subsequently, at step 608, the operator network receives a second communication (response) from the service provider directed toward the operator network (relayed by the end user device). Next at step 610, the operator network parses the response and recognizes the destination address as a known identifier for further processing. It should be noted that the known destination address does not have to physically exist as an application server location. The operator network then processes the response and attempts to provision and charge an account, associated with the end user device initiating the service request, for the cost of the service. Next at 612, if the provisioning and charging succeed, the operator network generates a third communication, encrypts an authentication data set and appends the encrypted authentication data set to the third communication. Next, at step 614, the operator network transmits the encrypted authentication data set toward the end user device.

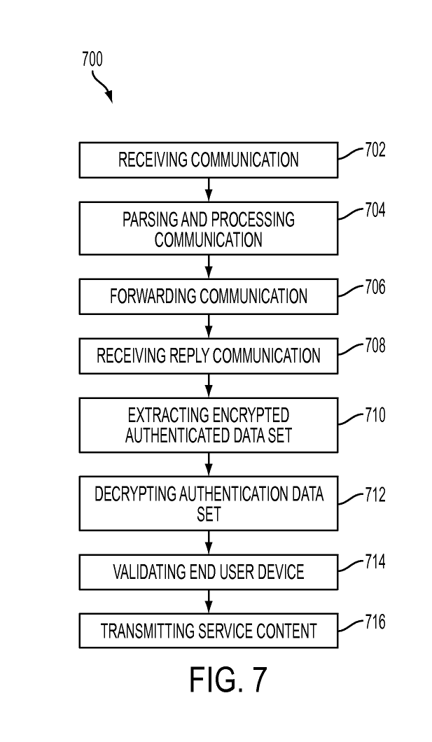

Looking now to FIG. 7, a method 700 for delivering an external service from a service provider to an end user device, associated with an operator network, and charging the operator network for the external service without accessing the operator owned end user device account information according to an exemplary embodiment is illustrated. Starting at step 702 the service provider receives a first communication from an end user device requesting access to a service. The service provider offers the service for sale and requires payment for the service before allowing the end user device service access.

Next at 704, the service provider parses the first communication and recognizes an identifier in the first communication as indicating the cost of this service can be charged to the account associated with the requesting end user device and owned by the network operator. Based on this recognition, the service provider processes the first communication and appends information related to requesting payment from the operator network for the requested service. The appended information is comprised of a charging server name, a service enabler identifying the requested service and an address associated with accessing the requested service. It should be noted that the appended information can further comprise an encrypted authentication data set for validating the identity of the service provider. The authentication data set would be encrypted by the private key of a public/private key pair owned by the service provider. Next at 706, the service provider forwards the amended first communication to the destination of the charging server name.

Continuing at 708, the service provider receives a second communication associated with the requested service and containing an encrypted authentication data set. The authentication data set was encrypted with the private key of a public/private key pair owned by the operator network. Next at 710, the service provider extracts the encrypted authentication data set from the second communication and at 712, decrypts the encrypted authentication data set using the public key of a public/private key pair owned by the operator network. It should be noted that the public key owned by the operator network was previously provided to the service provider.

Next at step 714, the service provider examines the decrypted authentication data set and confirms the requesting end user device is validated to receive the service and the operator network accepts the obligation to pay the service provider the cost of the service. Next at 716, the service provider transmits the service toward the end user device. It should be noted that the service provider can maintain copies of the authenticated data set as a receipt for delivering the service and entitlement for payment.

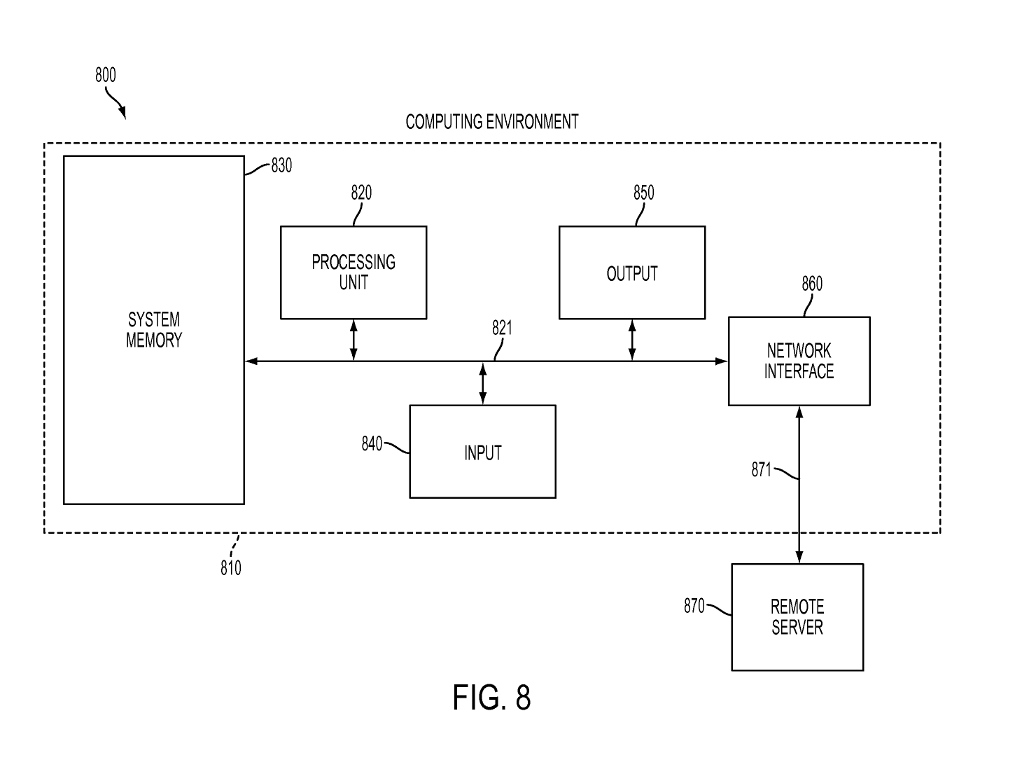

FIG. 8 illustrates an example of a suitable computing system environment 800 in which the claimed subject matter can be implemented, although as made clear above, the computing system environment 800 is only one example of a suitable computing environment for a mobile device and is not intended to suggest any limitation as to the scope of use or functionality of the claimed subject matter. Further, the computing environment 800 is not intended to suggest any dependency or requirement relating to the claimed subject matter and any one or combination of components illustrated in the example operating environment 800.

Looking now to FIG. 8, an example of a device for implementing the previously described innovation includes a general purpose computing device in the form of a computer 810. Components of computer 810 can include, but are not limited to, a processing unit 820, a system memory 830, and a system bus 821 that couples various system components including the system memory to the processing unit 820. The system bus 821 can be any of several types of bus structures including a memory bus or memory controller, a peripheral bus, and a local bus using any of a variety of bus architectures.

Computer 810 can include a variety of computer readable media. Computer readable media can be any available media that can be accessed by computer 810. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media can embody computer readable instructions, data structures, program modules or other data in a modulated data signal such as a carrier wave or other transport mechanism and can include any suitable information delivery media.

The system memory 830 can include computer storage media in the form of volatile and/or nonvolatile memory such as read only memory (ROM) and/or random access memory (RAM). A basic input/output system (BIOS), containing the basic routines that help to transfer information between elements within computer 810, such as during start-up, can be stored in memory 830. Memory 830 can also contain data and/or program modules that are immediately accessible to and/or presently being operated on by processing unit 820. By way of non-limiting example, memory 830 can also include an operating system, application programs, other program modules, and program data.

The computer 810 can also include other removable/non-removable and volatile/nonvolatile computer storage media. For example, computer 810 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 821 through a non-removable memory interface such as an interface, and a magnetic disk drive or optical disk drive can be connected to the system bus 821 by a removable memory interface, such as an interface.

A user can enter commands and information into the computer 810 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 820 through user input 840 and associated interface(s) that are coupled to the system bus 821, but can be connected by other interface and bus structures, such as a parallel port, game port or a universal serial bus (USB).

A graphics subsystem can also be connected to the system bus 821. In addition, a monitor or other type of display device can be connected to the system bus 821 through an interface, such as output interface 850, which can in turn communicate with video memory. In addition to a monitor, computers can also include other peripheral output devices, such as speakers and/or printing devices, which can also be connected through output interface 850.

The computer 810 can operate in a networked or distributed environment using logical connections to one or more other remote computers, such as remote server 870, which can in turn have media capabilities different from device 810. The remote server 870 can be a personal computer, a server, a router, a network PC, a peer device or other common network node, and/or any other remote media consumption or transmission device, and can include any or all of the elements described above relative to the computer 810. The logical connections depicted in FIG. 8 include a network 871, such as a local area network (LAN) or a wide area network (WAN), but can also include other networks/buses.

When used in a LAN networking environment, the computer 810 is connected to the LAN 871 through a network interface or adapter. When used in a WAN networking environment, the computer 810 can include a communications component, such as a modem, or other means for establishing communications over a WAN, such as the Internet. A communications component, such as a modem, which can be internal or external, can be connected to the system bus 821 through the user input interface at input 840 and/or other appropriate mechanism.

In a networked environment, program modules depicted relative to the computer 810, or portions thereof, can be stored in a remote memory storage device. It should be noted that the network connections shown and described are exemplary and other means of establishing a communications link between the computers can be used.

Additionally, it should be noted that as used in this application, terms such as “component,” “display,” “interface,” and other similar terms are intended to refer to a computing device, either hardware, a combination of hardware and software, software, or software in execution as applied to a computing device implementing a virtual keyboard. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

Further, the term to “infer” or “inference” refer generally to the process of reasoning about or inferring states of the system, environment, user, and/or intent from a set of observations as captured via events and/or data. Captured data and events can include user data, device data, environment data, behavior data, application data, implicit and explicit data, etc. Inference can be employed to identify a specific context or action, or can generate a probability distribution over states, for example. The inference can be probabilistic in that the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The above-described exemplary embodiments are intended to be illustrative in all respects, rather than restrictive, of the present innovation. Thus the present innovation is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method, stored in a memory and executing on a processor, for provisioning and charging on an operator network, an external service selected by an end user device associated with said operator network, the method comprising:
receiving, at said operator network, a first communication from said end user device;
appending, by said operator network, a parameter, identifying said operator network, to said
first communication;
forwarding, from said operator network, said first communication toward a first
destination associated with said external service and specified in said first communication;
receiving, at said operator network, a second communication, replying to said first
communication;
parsing, by said operator network, said second communication and, based on
recognizing an identifier specified in said second communication as identifying said operator network;
processing said second communication to charge an account, associated with said end user device, for use of said external service;
encrypting, by said operator network, an authentication data set using a key associated with
said operator network; and
transmitting, by said operator network, a third communication comprising said encrypted
authentication data set toward said end user device.

2. The method of claim 1, wherein processing said second communication further comprises provisioning, by said operator network, said external service on said account.

3. The method of claim 1, wherein processing said second communication further comprises decrypting an authentication data set encrypted using a private key associated with a service provider.

4. The method of claim 1, wherein said communications are Hypertext Transfer Protocol (HTTP) communications.

5. The method of claim 4, wherein said parameter, identifying said operator network, is a uniform resource locator (URL).

6. The method of claim 5, wherein said URL is a fictitious location associated with said operator network.

7. The method of claim 1, wherein said first destination is a service provider associated with said external service.

8. The method of claim 1, wherein said first destination is a payment provider associated with said external service.

9. The method of claim 1, wherein said key is a private key of a public/private key pair associated with said operator network.

10. The method of claim 1, wherein said authentication data set further authorizes a plurality of additional end user devices associated with said account.

11. The method of claim 4, wherein said third communication is an automatic redirection URL addressed to said end user device.

12. The method of claim 1, wherein said first communication is received by a Gateway General Packet Radio Service (GPRS) Support Node (GGSN) associated with said operator network.

13. The method of claim 1, wherein said processing of said second communication occurs on an online charging system (OCS) associated with said operator network.

14. A method, stored in a memory and executing on a processor, for delivering an external service from a service provider to an end user device, associated with an operator network, and charging said operator network for said external service without said service provider accessing an account, associated with said end user device and located on said operator network, the method comprising:
receiving, at said service provider, a first communication from said end user device
requesting said external service;
parsing, by said service provider, said first communication and based on recognizing an
identifier specified in said first communication as identifying said operator network, processing said first communication to request authorization from said operator network to charge said account for said external service;
forwarding, from said service provider, said first communication toward a first
destination;
receiving, at said service provider, a second communication from said operator
network requesting said external service and comprising an authentication data set,
encrypted by said operator network;
extracting, by said service provider, from said second communication, said encrypted
authentication data set;
decrypting, by said service provider, said authentication data set using a key associated with
said operator network;
validating, by said service provider, said end user device is authorized to receive said external service and said account has been charged; and
transmitting, by said service provider, said external service toward said authorized end user device.

15. The method of claim 14, wherein said first communication and said second communication are Hypertext Transfer Protocol (HTTP) communications.

16. The method of claim 15, wherein processing said first communication comprises:
generating an automatic redirection uniform resource locator (URL) addressed toward a charging server name;
appending a service identity attribute to said automatic redirection URL; and
appending an external service location attribute to said automatic redirection URL.

17. The method of claim 16, wherein said external service location attribute is an URL addressing an application server on said operator network.

18. The method of claim 14, wherein said key is a public key of a public/private key pair associated with said operator network.

19. The method of claim 14, wherein said authentication data set comprises:
an URL addressing the location of said external service; and
a timestamp associated with said external service.

20. The method of claim 19, wherein said timestamp specifies how long said end user device is authorized to use said external service.

21. The method of claim 19, wherein said timestamp specifies when said end user device purchased use of said external service.

22. The method of claim 16, wherein said service identity instructs said operator network to debit said account for the cost of use of said external service.

23. The method of claim 16, wherein said service identity instructs said operator network to credit said account for the cost of use of said external service.

24. The method of claim 14, wherein processing said first communication further comprises encrypting an authentication data set with a private key associated with said service provider and appending encrypted said authentication data set to said first communication.

25. A communications node comprising:
a network interface configured to receive a first communication from an end user device;
a processing unit configured to append a parameter, identifying an operator network to said
first communication and to forward said first communication toward a first destination associated with an external service and specified in said first communication;
wherein said network interface is further configured to receive a second communication as a
reply to said first communication;
wherein said processing unit is further configured to parse said second communication and,
based on recognizing an identifier specified in said second communication as identifying said operator network, to process said second communication to charge an account, associated with said end user device, for use of said external service;
wherein said processing unit is further configured to encrypt an authentication data set using
a key associated with said operator network, and to transmit a third communication comprising said encrypted authentication data set toward said end user device.
